(19) United States
(12) Patent Application Publication
(10) Pub. No.: US 2017/0138333 A1
(43) Pub. Date: May 18, 2017

(54) MODULAR HYDROKINETIC MOTOR DEVICE AND METHOD

(71) Applicant: Corporacion Andina De Fomento, Altamira (VE)

(72) Inventor: Jose TORAN, Distrito Capital (VE)

(21) Appl. No.: 15/353,241

(22) Filed: Nov. 16, 2016

Related U.S. Application Data
(60) Provisional application No. 62/255,884, filed on Nov. 16, 2015.

(51) Int. Cl. F03B 17/06

(52) U.S. Cl. CPC F03B 17/062; F05B 2220/706; F05B 2260/50; F05B 2260/421; F05B 2240/93

(57) ABSTRACT

The modular hydrokinetic motor device is a power generation apparatus for generating power from water flows. The power generation apparatus has a transducer from hydraulic to mechanical energy with a hydraulic side and a mechanical side. A generator is coupled to the mechanical side of the transducer. The hydraulic side of the transducer has a guiding mechanism and a series of paddles adapted to move along the guiding mechanism. The guiding mechanism has a driving path that defines a linear movement along the guiding mechanism in a downstream direction and a driven path that defines a linear movement along the guiding mechanism in an upstream direction. The driving path and the driven path are parallel paths. The apparatus is configured so that the driving path have a higher dragging coefficient than the driven path.

### CROSS REFERENCE TO RELATED APPLICATION

This application claims the benefit of priority of U.S. Provisional Patent Application No. 62/255,884, filed on Nov. 16, 2015, the application which is incorporated herein in its entirety.

### FIELD OF THE INVENTION

The present invention relates to a modular device driven by fluid currents to generate back and forth linear movement of elements with the objective of generate mechanical and electrical power. In particular, the present invention is directed toward a physical embodiment composed by at least two moveable elements called paddle, one of them being partially or completely submerged on the current, being moved downstream by it, while the other element is taken out of the water current while being pulled upstream by any mechanical transmission element moved by the first element, in order to repeat cycles of alternative back and forth movements while converting the linear movement of the paddles, relative to a floating structure that keeps the in position and provides guidance, into rotational movement in a shaft, mainly to drive an electrical generator but not limited to drive any other mechanical or electrical device.

### BACKGROUND OF THE INVENTION

The development and marketing of hydrokinetic renewable energy technologies of low (5 kW) and medium (250 kW) power to provide energy to isolated rural communities near navigable rivers in basins around the world, such as the West Amazon basin and others in Africa and Asia, is a short-term priority due to the high costs of electric energy in isolated communities in these basins. Currently, the governments of these regions are interested in improving the quality of life of communities there, and in reducing the high subsidies that are currently being used to provide energy to these areas. Electric power in these communities is usually provided by small diesel generators that are very costly to operate (diesel must be transported hundreds of kilometers through boats).

Given the geographic, ecologic, and climatic characteristics, as well as the difficult access, areas such as the central part of the West Amazon basin have few economically feasible technological alternatives to bring electricity to their communities. The conventional network extension modality commonly used to provide electricity to rural communities and to connect them to the interconnected system is not feasible in these areas not only because of their distances, but also due to the density of the tropical forest, and how inaccessible and dispersed the communities are.

Another conventional modality currently used to provide electricity to isolated rural communities such as the West Amazon, is bringing electricity through network extensions of the isolated systems under concession. The use of this modality is only feasible in communities that are relatively close to departmental or provincial capitals that have isolated systems under concession. Electricity has already been provided to one part of the West Amazon area through the extension of the network from diesel generation isolated systems, located primarily in the provincial and municipal capitals.

The introduction of new technologies to provide electricity to isolated communities in tropical basins is a way to solve this problem, while at the same time providing support to the technological capacities to strengthen the region's innovative system.

Hydrokinetic energy conversion systems from river currents have been implemented since ancient times. The development of hydrokinetic energy converters for high-flow rivers, but with very low hydraulic or water head, is in its beginning stages. There are very few technologies available on the market, currently only two: a) Garman axial flow-type turbines; and b) Darrieus cross flow vertical axis turbines. The available Garman turbines have a very low capacity (1 to 2 kW), but greater capacity Darrieus-type turbines can be found in the market (5 to 25 kW). Both types of turbines need a minimum speed of 1.5 m/s to work effectively, and this would limit its use in a great number of the rivers considered in the central area of the West Amazon basin, where the average speed of the flow of water is between 0.9 to 1.3 m/s. Both types of turbines would also be exposed to the risk of being hit by floating material (trees, branches, roots, etc.), which is very common in Amazon rivers.

Therefore, there is the need for the development of technological concepts oriented to work effectively (i.e., generate electricity affordably) in rivers with the conditions and characteristics mentioned above. These new technologies should comply with the following parameters: a) the concept should be modular, and should include the full hydrokinetic energy conversion systems or processes, and function independently from other structures; b) the main source of energy is hydrokinetic, considering speeds of river flows ranging between 0.9 to 1.5 m/s; c) the concept should be designed for capacities starting from 1 kW of power and up; d) the concept consider the risks of being impacted with floating material (trees, branches, roots, etc.), which are very common in navigable rivers, especially in basins such as the Amazon Basin and others.

### SUMMARY OF THE INVENTION

The present invention relates to a modular array of paddles, with relative movement with respect to a fixed floating structure that contains and provides them guidance, which converts the hydrokinetic energy of a water source, specially low speed currents ones, into mechanical movement of the moveable paddles. The paddles descript an alternative linear movement downstream (forth) and upstream (back), depending when their area is submerged into the current, being moved by effect of the drag force of the current acting on its facing surface, or when they are out of the water being pulled upstream by means of a mechanical transmission element, driven by other paddle which is being moved downstream at the same specific moment or by the energy supplied by an mechanical accumulator. The linear movement of the paddles is converted into mechanical rotation of a shaft or into another linear mechanical movement, in order to drive any mechanical device or electrical generator.

It is the main objective of the present invention to use the hydrokinetic energy of a water current source in order to transform it into mechanical or electrical power.

It is another objective of the present invention to allow easy placement of the device on any spot of a water channel, mainly rivers, depending on the characteristics of such channel, especially due to seasonal changes in flow, water level, sediments or any other reason associated to improve device performance, safety, or convenience, without requiring any major civil foundations or construction. It is also an objective of this invention to operate in a reliable way in remote areas with no human attendance during operation and minimal maintenance intervention

It is another objective of the present invention to provide a resistant structure and mechanisms to survive for collisions with elements being dragged by the water current.

It is another objective of the present invention to be easily transported long distances by any means, especially when being towed or shipped by any small or medium size river crafts.

It is another objective of the present invention to provide a device that can be easily adjusted to operate at a fixed spot in the channel with variations of depth level due to sediments and seasonal tides.

It is another objective of this invention to provide motor modules that can be combined in different arrangements in order to achieve objectives like output power increment, output power uniformity, maximize benefit of water source conditions and adaptations to changes on the water source channel.

It is another objective of the present invention to easily increase or reduce modules of power generation according to the energy demand or user requirement. It is also an objective to scale the size of the elements depending on the flow or demand conditions.

It is another objective of the present invention to provide an easy to maintain device considering it may be operating in remote areas far from technical service providers or spare parts suppliers.

In concrete, the present invention discloses a power generation apparatus for generating power from water flows, the power generation apparatus comprising: a transducer from hydraulic to mechanical energy comprising a hydraulic side and a mechanical side; and a generator coupled to the mechanical side of the transducer. Also, it is envisaged that the hydraulic side of the transducer comprises a guiding mechanism and a series of paddles adapted to move along the guiding mechanism, the guiding mechanism comprising: a driving path that defines a linear movement along the guiding mechanism in a downstream direction; and a driven path that defines a linear movement along the guiding mechanism in an upstream direction, being the driving path and the driven path parallel paths and being the apparatus configured so that the driving path have a higher dragging coefficient than the driven path. The dragging coefficient can be configured by modifying the fluid in which the paddles move (e.g., by having the paddles go underwater during the driving cycle and over the water in the driven cycle), by changing the effective area of the paddles in contact with the water flows (e.g., by rotating or modifying the shape of the paddles such as, opening/closing windows, etc.)

Also, it is provided a modular floating device for power generation, mainly composed by fixed elements, moveable elements, transmission elements and power generation elements. The fixed elements are the rigidity platforms and the floating walls, which besides of giving resistance and stability to the device, are in charge of keep floating the whole device, and provide guidance for the linear and swinging movements of the paddles, defining two parallel channels where the water will flow through. The moveable elements are the paddles, moving in opposed directions at any time, on each one of the channels mentioned before, being at certain part of the cycle one of them the driving paddle and the other the driven one, switching this function at the end of each stroke. The movement of each paddle describes a cycle with four well defined stages, two linear displacement stages called strokes, and two transition stages which combine rotation and displacements. One of the strokes is called the driving stroke, it occurs when, e.g., in a particular embodiment, one of the paddles (so called driving paddle) is entirely or with part of its surface submerged on the current, in order to face the maximum surface perpendicular to the current direction, which makes it move downstream by dragging. During this stroke the paddle drives or moves the transmission element. The other stroke is called the driven stroke, and it occurs when, in a preferred embodiment, the paddle is substantially out of the water, in order to oppose minimal resistance when it moves upstream while being pulled by the transmission element. In both strokes paddles are restricted to move lineally parallel to the current, with defined start and end, in downstream (forth) and upstream (back) direction because of the guiding constraints located on the floating walls. In essence, as the paddles move in a downstream direction they move along a guide following a driving path and as the paddles move in an upstream direction they move along a guide following a driven path.

In order to ensure a continuous movement of the paddles once they reach the end of the stroke, it is provided a guide mechanism allocated on the floating walls, to allow them to turn out of the water in the case of the driving paddle or into the water in the case of the driven paddle. This swinging movement is driven by the transmission element, taking the power from both the driven paddle movement and inertia, and an energy accumulator element, mainly flywheels, counter weight or spring based mechanisms attached to the transmission or the paddle itself, being loaded during the travel of the driving paddle. The swinging movement to make the driven paddle sink into the current to start its driving stroke requires a turning movement with opposite direction to the one made to take it out of the water at the end of the driving stroke. A no-return mechanism is provided to accomplish this paddle movement ensuring it moves always on the appropriate direction.

The movement of the driving paddle is transmitted to the driven paddle through the transmission elements being such transmission elements understood as a hydraulic to mechanical transducer. Different ways to provide such transmission include in first place a continuous chain attached to every paddle, being guided by free sprockets and driven sprockets; in second place, a rack and pinion system, in third place any belt and pulleys array, in fourth place any kind of mechanical transmission like worm and nut, and in fifth place any kind of mechanically linked bars mechanism. When one of the paddles moves downstream on its driving stroke, it pulls or produces a displacement on the transmission element, which at the same time will pull the other paddle moving it upstream while on the driven stroke. The movement of the transmission element generates a rotation or displacement (mechanical energy) that will be transformed into electrical power by means of a generator.

The apparatus is kept in position in the water source or channel, aligned parallel with the water current by means of tensioning cables attached to the front (upstream) side and rear (downstream) sides of the floating walls. The tensioning cables are attached in one side to the floating walls hubs, located in the above-water and under-water sides of the wall and in the other side are attached to a fixed element outside the device, whether on the river or on the shore line. The floating walls form a channel geometry in which the water gets in and moves the driving paddle which is placed obstructing the water flow. The entrance of the water into the channel has funnel type geometry in order to increase the flow through the device, increasing the speed of the water as it goes thru.

All the mechanical transmission elements may be located outside of the water in order to minimize failures due to collision or jams with debris or elements being dragged by the water current, as well as to minimize maintenance because of corrosion and lack of lubrication. As the movement of the transmission element will invert its direction every time the paddles switch from a driving stroke onto a driven stroke, it is provided a mechanical transmission element that inverts the turning of the output shaft in order to obtain an unidirectional movement at the generator element no matter which paddle is on the driving stroke.

The floating walls are independent modules which connect themselves through structural rigid elements which provide rigidity to the assembly. Every floating wall consists of a void light solid which can vary its floating level by filling or draining the water inside it, by means of a pumping system. As the drag force produced by the water current onto the submerged paddle is proportional to the projected area of the paddle perpendicular to the flow, the change on the floating level of the floating walls represents a mechanism to increase or reduce the force on the paddles and directly to the power generated. Also, the change on the floating level makes the device suitable to different conditions of water depth mainly dependent to seasonal changes of the river, and allocation on different spots of the water source with different depth level.

A single motor module is a combination of one or two paddles which can accomplish a complete cycle. The one-paddle module requires an accumulator element which loads its energy during the driving stroke of the paddle, and uses its accumulated energy to supply the force required by the paddle to perform the transition phases and the driven stroke. This one-paddle motor module running alone is not an effective power generation method, because the energy drawn from the water current during the driving stroke of the paddle is mostly accumulated to drive later the upstream movement of the same paddle, remaining a small energy amount to drive the power generation elements, and even could not have enough energy accumulated to make any power generation during the driven stroke. The case of the two-paddles module motor is a more effective method for power generation, because the energy produced during the driving stroke of any paddle is used directly to drive the power generation elements and to pull the driven paddle moving upstream.

The present invention has three different embodiments, all of them applying the same method and elements, but varying the principles of guidance and restraints of the paddles with the floating walls.

The first embodiment (also called the preferred embodiment) consists of paddles with four mechanical followers, two in each lateral side, one of them on the upper most part of the paddle when in vertical orientation as when it moves on the driving stroke, this one being outside of water in every moment, and the other on the lower part of the paddle, being under water during the driving stroke and outside of the water when on the driven stroke. The four followers are restricted to move along a guide element located on the inner side of the floating wall, forcing the paddle to move with a determined orientation during each stage of the cycle. There are two independent guides on every floating wall, one for the upper follower and one for the lower follower, on each side of the paddle.

The second embodiment consists of paddles with four followers each as in the first embodiment, but with all of the followers located on the upper side of the paddle (as when it is vertically oriented on the driving stroke), being all of the followers out of the water in every stage of the cycle. The followers are restricted to move on two independent guides located on the inner side of the floating walls. This embodiment presents certain advantages from maintenance and reliability with respect to the first embodiment, but could limit the force being applied to the paddle by the water current, limiting its size.

The third embodiment consists of a different guidance system for the paddles. There is a single follower on the upper side of the paddle on each lateral side, having a unique guide to describe the movement of the paddle along the cycle. To allow the paddle to rotate during the transition stages this embodiment is provided with a lock-unlock mechanism which allows the paddle to rotate relative to its guiding followers, in order to move out of the water current at the end of the driving stroke, and to rotate to sink into the current flow at the end of the driven stroke. The single guide is located at the top of the floating walls and all the guidance elements are out of the water in every part along the cycle.

The hydrokinetic motor modules can be combined or gathered in multiple ways in order to achieve the goals of power generation, improve the device operation or better adapt to the conditions of the water source. The main combinations proposed are:
a) Series arrangements: Modules are connected side by side, sharing or not the floating walls between modules, receiving all of them the
b) Parallel arrangements: Modules are connected consecutively downstream, in such a way the water exiting one module will flow through the next module located downstream of it.
c) Mixed: Some modules are connected in series, some in parallel, and the modules can be aligned of staggered.
d) With or without synchronicity or phasing of the paddles of different modules.
e) With Independent or interconnected power generation elements between modules
f) With Different or equal sized modules or elements
g) With Number of paddles or modules from one up.
h) With Even or odd number of paddles.

The modularity of the present invention not only relates to the independent motor modules which can be arranged together as mentioned, but also relates to the elements composing every single module. The floating walls are intended to be a unique part which is assembled as many times as required, being interchangeable between modules, representing an advantage from a maintenance point of view and also from a manufacturing point of view, because of the reduction on part or asset numbers and its associated saving in tooling. For this reason the floating walls include the same guidance features on both sides, allowing the addition of new motor modules by sharing at least one of the floating walls of the already assembled modules.

In the case of the paddles, they are also considered to be a modular element. In first place all the paddles on the motor are intended to be the same part, repeated as many times as modules, and in second place, the modularity of the paddle is referred to the functionality of adding several individual modular paddle parts together to create a new composed oversized paddle which represents a bigger area and as a consequence it will produce a higher dragging force from the current.

There is not a fixed dimension for any of the elements, because the bigger the paddle area the higher the force obtained from the water current, and the larger the stroke the better the continuity of the system, considering that larger pieces represent disadvantages to manufacturing and transportation of such elements.

### BRIEF DESCRIPTION OF THE DRAWINGS

FIG. 1 is a general isometric view of the first embodiment of a two-paddle single motor module during operation.

FIG. 2 is a general front view of the first embodiment of a two-paddle single motor module during operation on a water source.

FIG. 3 is a sequence of partial side views of the first embodiment of the apparatus with the four phases of an operating cycle with simultaneous position of the two paddles of an independent two-paddle motor module.

FIG. 4 is a general isometric view of first embodiment paddle.

FIG. 5 is a general top view of the first embodiment of a two-paddle motor module.

FIG. 6 is a partial isometric view of one floating wall and one paddle of the second embodiment of the apparatus.

FIG. 7 is a sequence of partial side views of the second embodiment of the apparatus with the four phases of an operating cycle with simultaneous position of the two paddles of an independent two-paddle motor module.

FIG. 8 is an isometric partial view of the third embodiment of a two-paddle motor module, with only the floating walls, the paddles and the guidance system during operation.

FIG. 9 is a partial isometric view of one floating wall, one paddle and its guidance system of the third embodiment of the apparatus.

FIG. 10 is a sequence of partial side views of the third embodiment of the apparatus with the four phases of an operating cycle with simultaneous position of the two paddles of an independent two-paddle motor module.

FIG. 11 is an array of two two-paddle motor modules operating assembled in parallel with synchronous phased paddles between modules.

FIG. 12 is an array of two two-paddle motor modules operating assembled in parallel with synchronous non phased paddles between modules.

FIG. 13 is an array of two two-paddle motor modules operating assembled in series with synchronous phased paddles between modules.

FIG. 14 is an array of two two-paddle motor modules operating assembled in series with synchronous phased paddles opposed in phase between modules.

FIG. 15 is an arrangement of two two-paddle motor modules in series staggered.

FIG. 16 is a hydrokinetic motor composed of modules assembled in parallel and series.

FIG. 17 is an arrangement of two two-paddles motor modules in series with different sized modules.

FIG. 18 is shows a wider sized modular composed paddle.

FIG. 19 is a regular modular paddle with an area enlarger.

FIG. 20 is a typical anchorage solution for a stationary hydrokinetic motor.

FIG. 21 is another typical anchorage solution for a stationary hydrokinetic motor, with wire mesh for protection.

FIG. 22 is an operating moveable hydrokinetic motor.

### DETAILED DESCRIPTION OF THE INVENTION

The following Figures are not to scale. The actual dimension and/or shape of each of the device components may vary. Only important details of the device are shown, however one of ordinary skill in the art can appreciate how the overall device may be constructed, without undue experimentation. As the main function of the device relates to transforming the drag force exerted by a water flow on a submerged paddle, it is theoretically well known that such dragging force is proportional to geometrical elements of the paddle (dragging coefficient and projected area perpendicular to the flow) and properties of the flow (speed and density), so certain small geometric or shape modification of the paddles with respect the shapes shown in these figures are considered in order to increase the dragging coefficient. Regarding the paddle size, as it is proportional to the drag force, it will depend on the desired level of power generation and the conditions of the water source where it will be placed.

There are one-paddle motor single modules and two-paddle motor single modules. For the following description all the motor modules considered will be two-paddle motor modules, but it is understood that one-paddle motor single modules follows exactly the same phases the each of the paddles of the two-paddle motor module, but with the only difference that the energy required for the paddle to perform the travel upstream (called driven stroke) is supplied by means of an energy accumulator element, loaded during the paddle moves downstream, instead of being supplied by another paddle movement as in the case of the two-paddle motor single module.

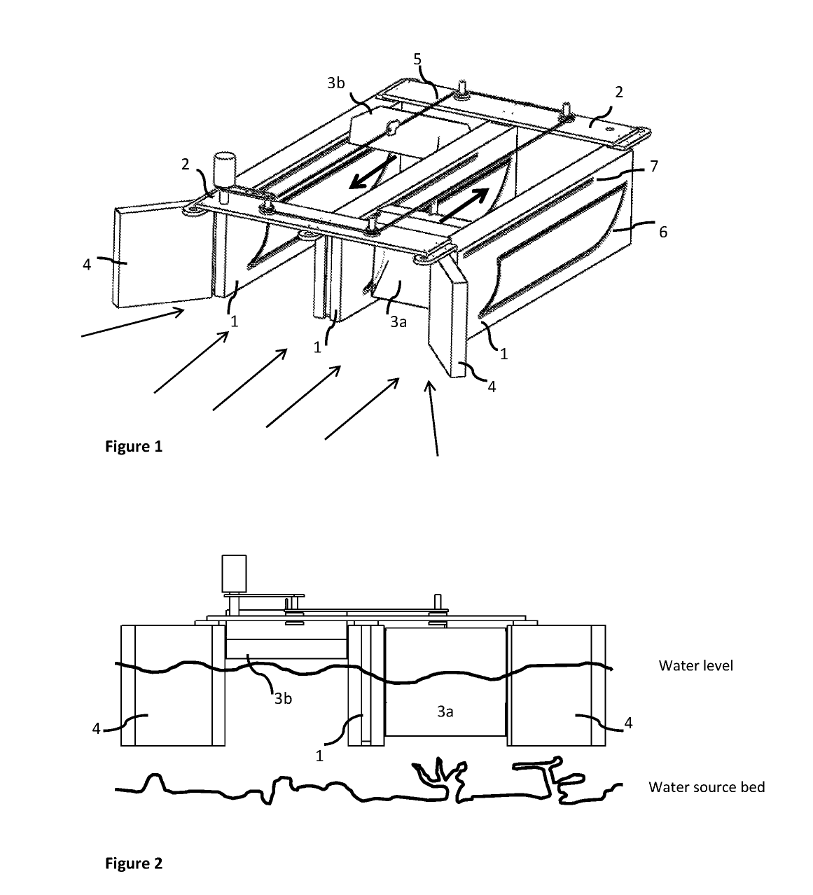

FIG. 1 is an isometric view of the Hydrokinetic Motor first embodiment with its main components during normal operation. The apparatus is composed by the floating walls 1 and the joining platforms 2 which compose the main frame of the device. The floating walls 1 are voided solids which keep the whole system on float and can vary its floating level by filling or emptying water from its inner cavity. Every device is composed of a minimum of three floating walls 1, oriented to be parallel to the lines of the water source flow in order to form two main flow channels where the water will go through at its highest velocity. In FIG. 1 there is the right channel where runs the paddle 3a which at that particular moment moves on the direction of the water flow (driving paddle), being dragged by it and on the left channel is paddle 3b, which at that moment is moving opposed to the water flow direction (driven paddle). The paddle 3a is located at the start of the driving stroke, sunk into the water facing its greater area perpendicular to the flow, in order of being dragged by the water current. Paddle 3b is completely or with most of its body out of the water in order to oppose the minimal resistance as it moves upstream. FIG. 2 is a general front view of the first embodiment and shows location of the paddles 3a and 3b respect with the water level for that particular moment. At the entrance of both channels of water there are the deflectors 4, which can be adjusted to different angles respect to the floating walls 4 where they are provided with a hinge-like joint. Both deflectors 4 have the function of increase the flux of water through the channels, increasing the velocity of the fluid which is proportional to the drag force on the paddles. FIG. 1 shows the transmission element 5 which links the movement of paddles, being pulled by the driving paddle (3a in that moment) and transmitting this movement to the driven paddle (3b in that moment). The paddles move lineally along the channel (this movement is called the stroke) and at the end of this movement they need to rotate to get into the water or out of it, depending if it is being dragged downstream (driving stroke) or if it is being pulled upstream (driven stroke).

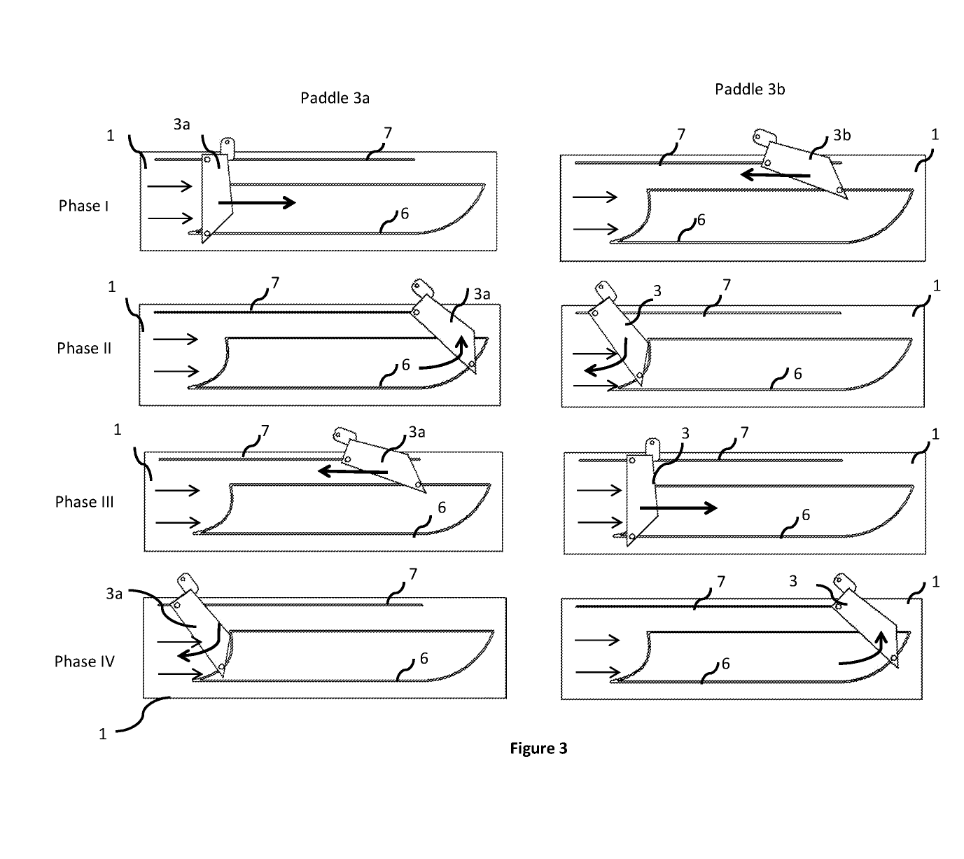

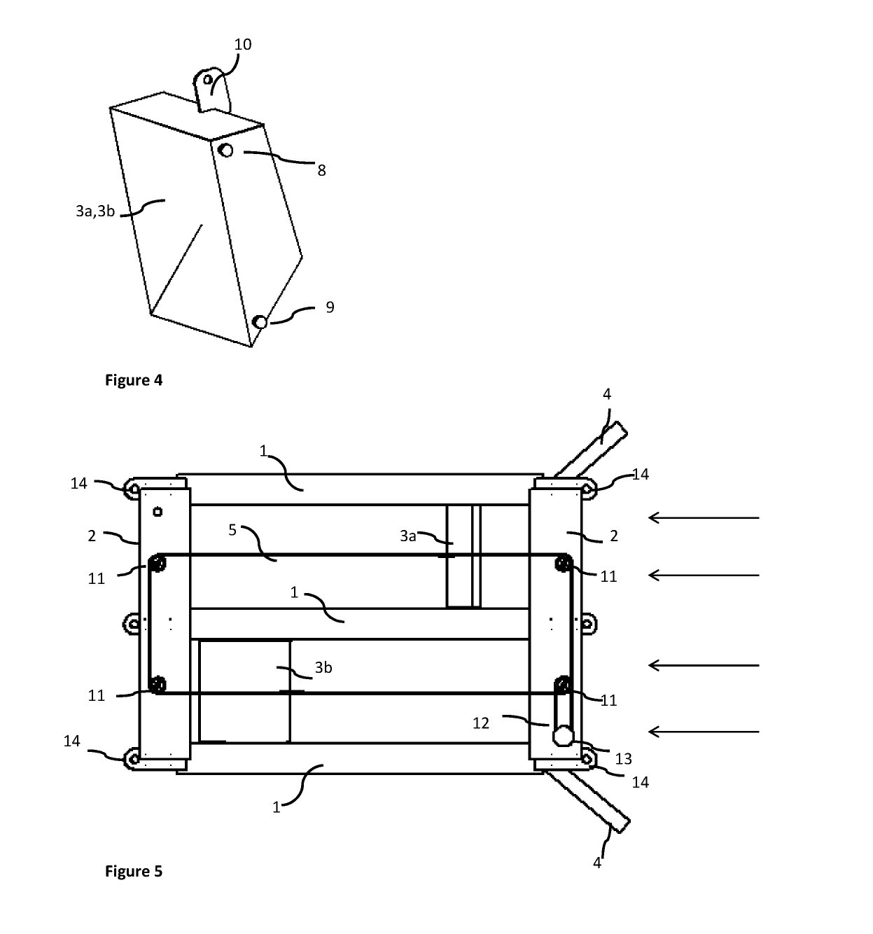

FIG. 3 shows the mechanics of the alternative movement of the paddles on a side view of the first embodiment of a two-paddle motor module, describing the four phases along a complete cycle of the motor, and the relative position between the two paddles. Phase 1 describes the paddle 3a at the beginning of the driving stroke, moving downstream being dragged by the water flow. At that moment paddle 3b is at the beginning of the driven stroke, moving upstream being pulled by the transmission element. From this moment up to the end of the phase I, the movement of the paddles is linear. The orientation of every paddle is determined by the guidance elements, mainly a system composed by four fixed guides located on the floating walls 1, the upper guides 7 and the bottom guides 6, in which will run the moving followers 8 at the top and 9 at the bottom of the paddle element 3a and 3b, as seen on FIG. 4. The phase 2 in FIG. 3 describes the transition after the paddle 3a reach the end of the driving stroke and swings to get out of the water, at the same time that the paddle 3b reach the end of the driven stroke and it needs to swing to sink into the water. The swinging movement to get out of the water is produced by the combined effect of the dragging force of water on the paddle, making it progressively rotate on its upper follower 8 located at the end of the guide 7, while the bottom follower 9 is able to move along the curved guide 6. The second effect that produces the swinging movement refers to the displacement of a counter-weight element 10 which progressively moves leftwards from the vertical line described by the follower 8 once the rotation has started. FIG. 4 shows the position of counter-weight element 10 which besides the mentioned function before is the element to link the transmission element 5 with the paddle 3a and 3b. Phase III described in FIG. 3 relates to the start of the driven stroke for the paddle 3a, moving lineally upstream while being pulled by the transmission element 5 Paddle 3a body is completely or partially out of the water. At the same time, the paddle 3b is already sunk into the water starting to be dragged by the water current (driving stroke). The phase IV describes the end of the driven stroke of the paddle 3a and the end of the driving stroke of the paddle 3b. During this phase the paddle 3a actually out of the water needs to rotate on its upper followers 8 when it reaches the end of the guide 7 in a counterclockwise direction (as seen on FIG. 3). A no-return mechanism is located on the guide 6 at the point where the followers 9 start to move downwards, to ensure that paddle 3a start to turn downwards following the guide 6 instead of returning on the way it came. At this phase, the movement of the paddle 3a rotating downwards into the water is produced by gravitational effect of the paddle weight and because of the progressive movement of the counter-weight 12 rightwards until it crosses the vertical line described by the follower 8. It is also considered the use of any other energy accumulator element like springs or fly-wheels loaded during the driving stroke, in order to release its accumulated energy to help the paddle to sink into the water, as the movement of the current will tend to move it upwards. At the same time the paddle 3b describes the transition movement to get out of the water, detailed on phase II for paddle 3a.

FIG. 5 is a top view of the first embodiment of a two-paddle motor module, and it shows the transmission and power elements of the apparatus. As mentioned before, the paddles 3a and 3b are linked together by a transmission element 5. This transmission element 5 requires some mechanical elements 11 to guide it, ensuring its position and for certain mechanisms to keep the tension on it. For the case of this embodiment those elements are toothed discs like sprockets or pulleys which rotate engaged with the transmission element 5. The turning on the shaft of these elements 11 can be used to drive any other transmission device or to drive an electrical generator. Some of the transmission devices considered are gearboxes and turning inverters, required to make the rotation of the generator at a determined speed and direction. Other of the devices foreseen to be coupled to these mechanical elements 11 are fly wheels and any other kind of mechanical accumulators, including spring based ones, potential energy accumulators like those based on the lifting of a weight, and any other kind of system consisting on pumping or compressing fluids to make pressure accumulator systems. All of these elements are black boxed represented in element 13, driven directly or through another mechanical transmission element 12.

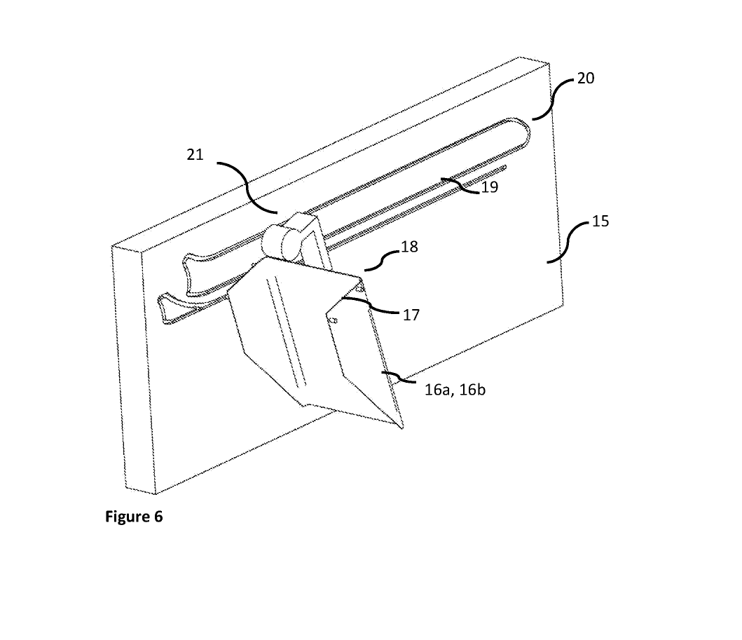

FIG. 6 is an isometric partial view of the second embodiment, of only one of the floating walls 15 and one of the two paddles 16a and 16b, and shows the differences on the guidance system respect to the first embodiment. The principle of work of this embodiment is mostly the same than the described for the first embodiment, but its main difference lays on the relocation of the followers 9 on the paddle as shown in FIG. 4 to putting followers 17 and 18 on the top side of the paddle (considering the paddle oriented when it is on the driving stroke), and as a consequence, the fixed guides on the floating wall 15 change being 19 (the one to guide the follower 17) and 20 (the one to guide follower 18). As the location of the followers 17 and 18 change the dynamics of the paddle, a more influence of the counter-weight element 20 is foreseen. The main advantage of the second embodiment is to keep all the guidance elements out of the water in every moment of the cycle of the motor, which represents an advantage when working with water sources with abundance of debris. It also represents an advantage when considering lubrication of the guidance system and corrosion of its elements. As a consequence of the position of the followers it could limit big sizes of the paddles, at least on the vertical direction.

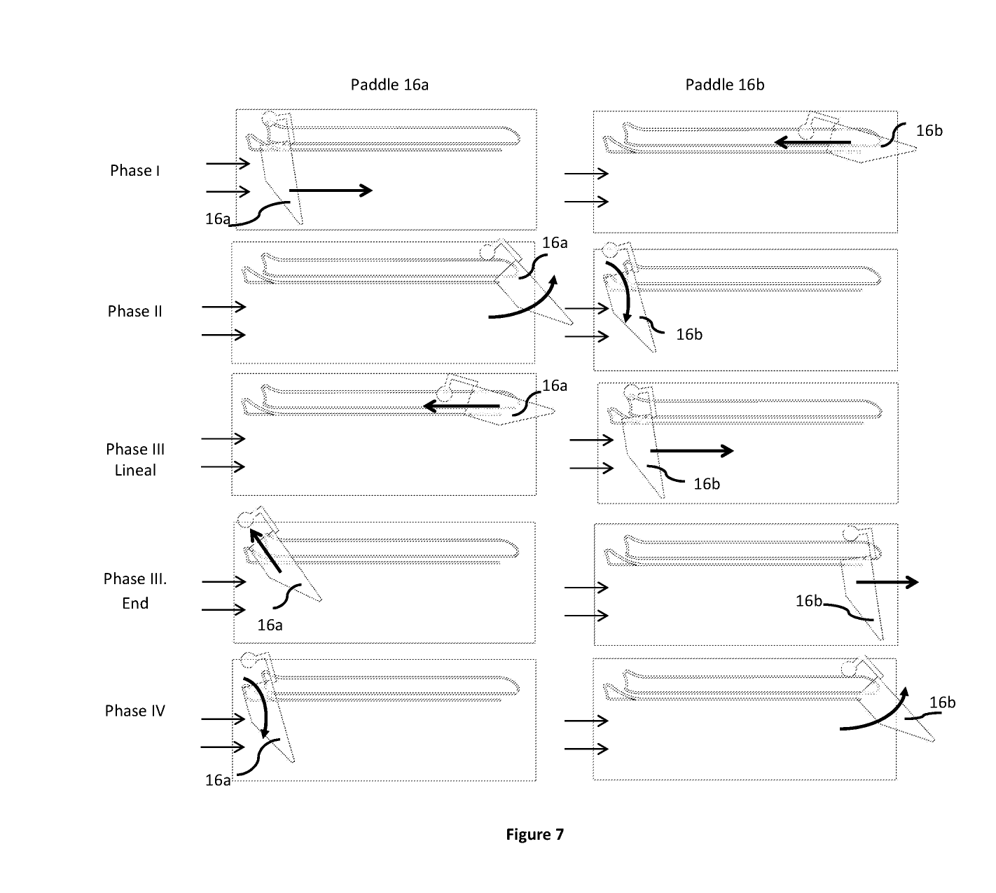

FIG. 7 describes one complete working cycle of the apparatus for the second embodiment of a two-paddle motor module on partial side views showing only one floating wall 15 and one paddle either 16a or 16b, at different moments of the four phases during the cycle. As in the case of the first embodiment the four phases are the driving stroke, the driven stroke and the two transitional phases. In addition to the geometrical differences on the fixed guides 19 and 20 to suit the movement of the paddles 16a and 16b and its followers 17 and 18, there is a difference on the driven stroke path, phase III on FIG. 7. At the end of phase III, the driven paddle which is out of the water moving leftwards (according to FIG. 7) is forced to move also upwards, in order to increase its potential energy (height respect water level) and also to leave room to allow it rotate on the next phase before getting into the water (it would require more energy to rotate inside the water specially because the rotation occurs countercurrent). The potential energy of the paddle and the change of position of the counter-weight element with respect to follower 17, provide the energy to rotate the paddle and sink it into the water in phase IV.

FIG. 8 is an isometric partial view of the third embodiment, with only the three floating walls 22, the two paddles 23a and 23b, and the guidance system 24. All the structural elements, transmission elements and generation elements are the same as in the case of the first embodiment, and are not included on FIG. 8 in order to easily explain the differences for this embodiment. The principle of work of the third embodiment is mostly the same than the described for the first embodiment, but its main difference lays on a simpler guidance system, consisting of a single fixed guide 25 at the top face of each floating wall 22, and a corresponding single follower 24 on each side of the paddle for such fixed guides. The top face of floating wall 22 may adopt the shape of the fixed guide or be similar to the one on the first embodiment 1 in FIG. 1. The curved shape on the fixed guide 25 allows the paddle to re-orientate at the end of the driven stroke in order to improve the dive into the water before the start of the driving stroke.

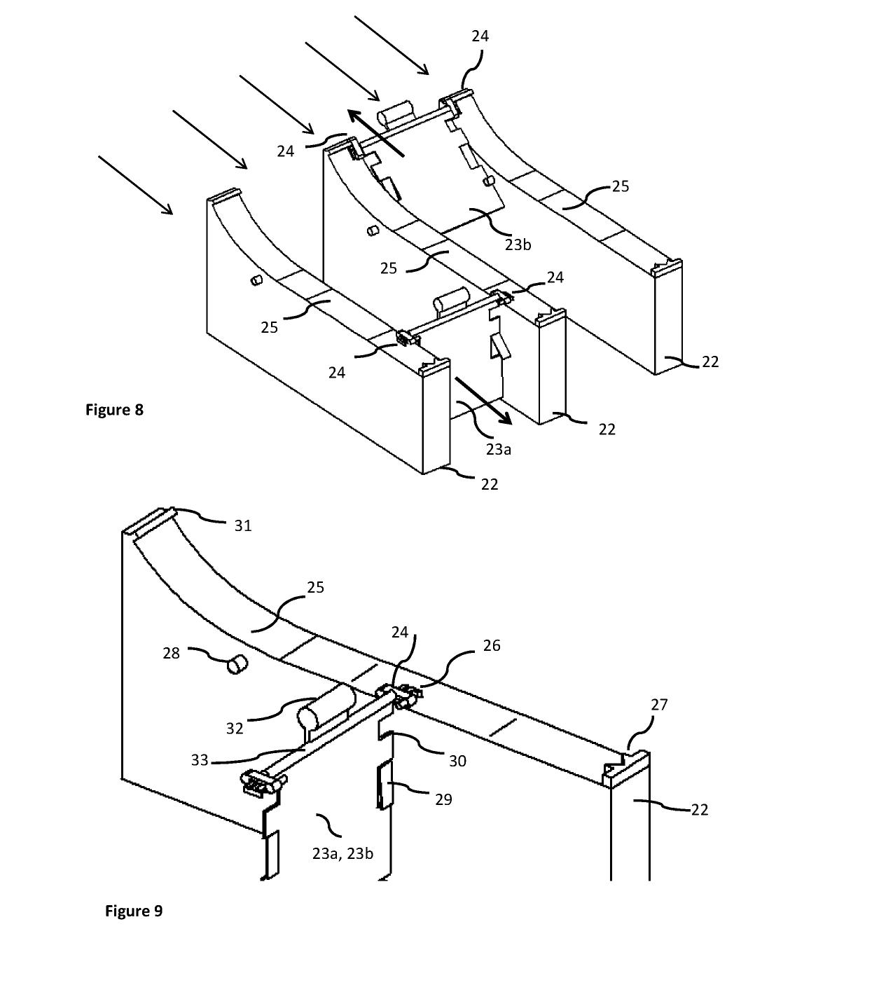

FIG. 9 is a detailed view of one of the floating walls 22, a paddle 23a or 23b with one follower 24 at each side, the fixed guide 25 at the top of the floating wall and some other elements explained as follows. As a consequence of the simpler guidance system on the third embodiment, it is required a mechanism to lock and unlock the relative rotation of the paddle 23a or 23b with respect to its follower 24. This mechanism 26 is activated or de-activated when the paddle reach the end of the driving stroke and the mechanism makes contact with the end stopper 27. The activation or de-activation process may consist on a lateral displacement of the mechanism 26 because of the progressive contact between two wedge-shaped opposing elements on the mechanism 26 and on the stopper 27 while they get closer as the paddle 23a or 23b moves downstream at the end of the driving stroke. Mechanism 26 should be spring loaded in order to return to its original position once the contact with the opposing wedge element 27 is lost as it moves upstream at the beginning of the driven stroke. As in the case of the other two embodiments, the apparatus requires a no-return mechanism to ensure the paddle 23a or 23b follows the correct path while reorienting at the transition between the driven stroke and the diving at the beginning of the driving stroke. Different elements may be used to accomplish this function however in FIG. 9 stopper 28 on the inner face of the floating wall 22 in combination with the one-way gate 29 and the open shape 30 both on the paddles 23a or 23b illustrate the working principle. When the paddle 23a or 23b is moving upstream while on the driven stroke, being pulled by the transmission element, the one-way gate 29 opens to allow the stopper 28 to pass thru, and it keeps moving until it reaches the end of the guide 31, rotating at the same degree that the curve of the fixed guide 25. Once the follower 24 stops with the end of the guide 31 it starts moving downwards and downstream. To produce the rotation of the paddle as it sinks into the water, while the follower 24 moves downstream along the fixed guide 25 the back face of the paddle 23a or 23b rolls over the stopper 28 and at the same time the counter-weight element 32 on the paddle moves over the rotation axis 33 of the paddle, which finally produces the rotation of the paddle. While the back face of the paddle 23a or 23b rolls over the stopper 28, the one-way gate 29 stays closed, by means of a spring loaded hinge mechanism or similar, allowing the stopper 28 move continuously all along the back face of the paddle, until it reaches the geometry opening 30. At that point, the stopper 28 passes thru the opening 30 and the mechanism 26 locks the paddle to stop any relative rotation between it and follower 24, starting the driving stroke of that paddle, being dragged downstream by the water current while keeping its straighten up orientation, with its major area perpendicular to the current. Mechanism 26 locking activation may occur by means of a wedged protruded body which is pushed aside by the rotation of the paddle against it, returning to its position once the paddle overpass it, restraining the paddle edge between the returned protruded body and another body which retracts when the mechanism is released by contact with stopper 27. Any other locking mechanism being part of the paddle or of any external component is also considered to accomplish the same function.

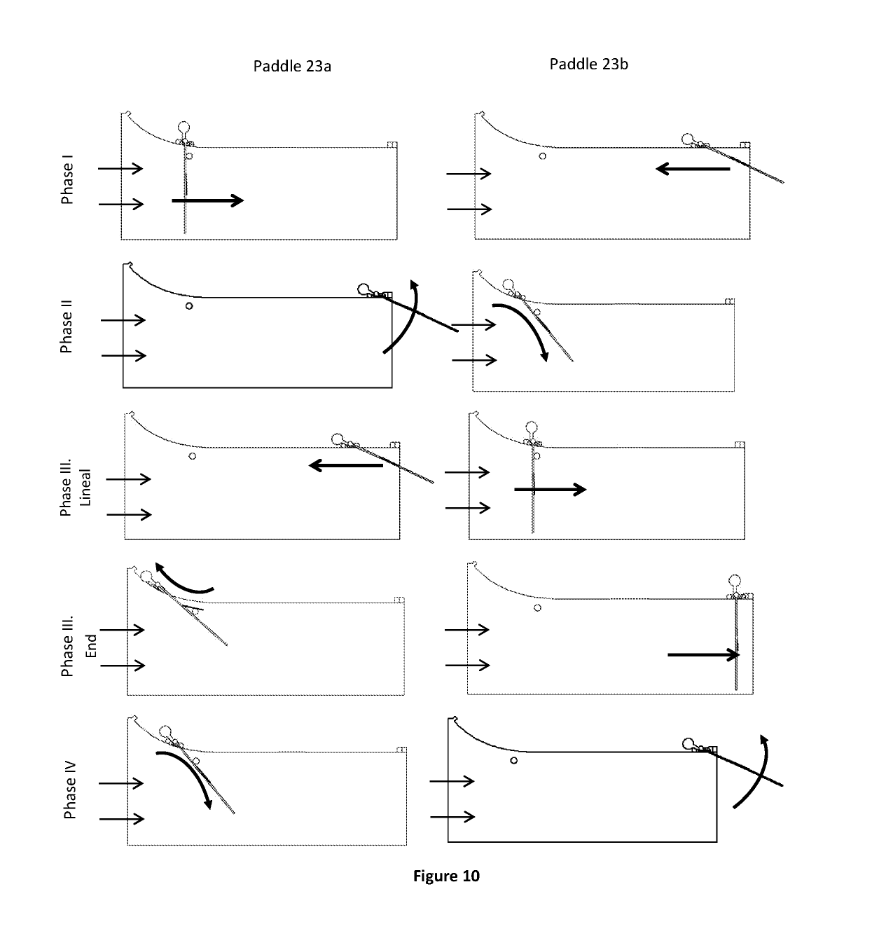

FIG. 10 describes the complete working cycle of the third embodiment of the apparatus for a two-paddle motor module on partial side views showing only one floating wall and one paddle each, at different moments of the four phases during the cycle. As in the case of the first and second embodiment of the apparatus the four phases are the driving stroke, the driven stroke and the two transitional phases. The phase I correspond to the driving stroke of the paddle 23a, which starts vertically aligned to be dragged downstream by the current, and the driven stroke of the paddle 23b, which is completely or with most of its surface out of the water, opposing a minimal resistance to the water current while it is pulled upstream by the transmission element. During the downstream travel paddle 23a keeps it vertical orientation by means of the locking mechanism 26 explained on FIG. 9. Once it reaches the end of the fixed guide 25, the locking mechanism is released and starts the transition phase II. In phase II the water current makes the paddle 23a to rotate around its axis 33, and the progressive displacement of the position of the counterweight 32 with respect to axis 33 makes the rotation take the paddle 23a to the orientation shown in FIG. 10. Paddle 23a doesn't require any other force that mentioned to accomplish the rotation. At the same time paddle 23b is starting to sink into the water with the procedure already explained, by effect of its weight and the dragging force of the current which progressively enters in contact with the paddle. Phase III of paddle 23a is the lineal movement explained for the driven stroke, and at closer to the end of the fixed guide, it moves along the curve described by the guide, increasing its relative vertical position respect the water level as well as turning onto a more vertical orientation. The force to make paddle 23a climb over the curve of the fixed guide comes from the paddle 23b which at that moment is still being dragged by the current at the end of its driving stroke. In Phase IV paddle 23a displaces and rotates to sink into the water while paddle 23b rotates to get out of it, by the procedures already explained.

The three embodiments are composed by the same transmission and generation elements, reason why those elements have only been explained in detail for the first embodiment.

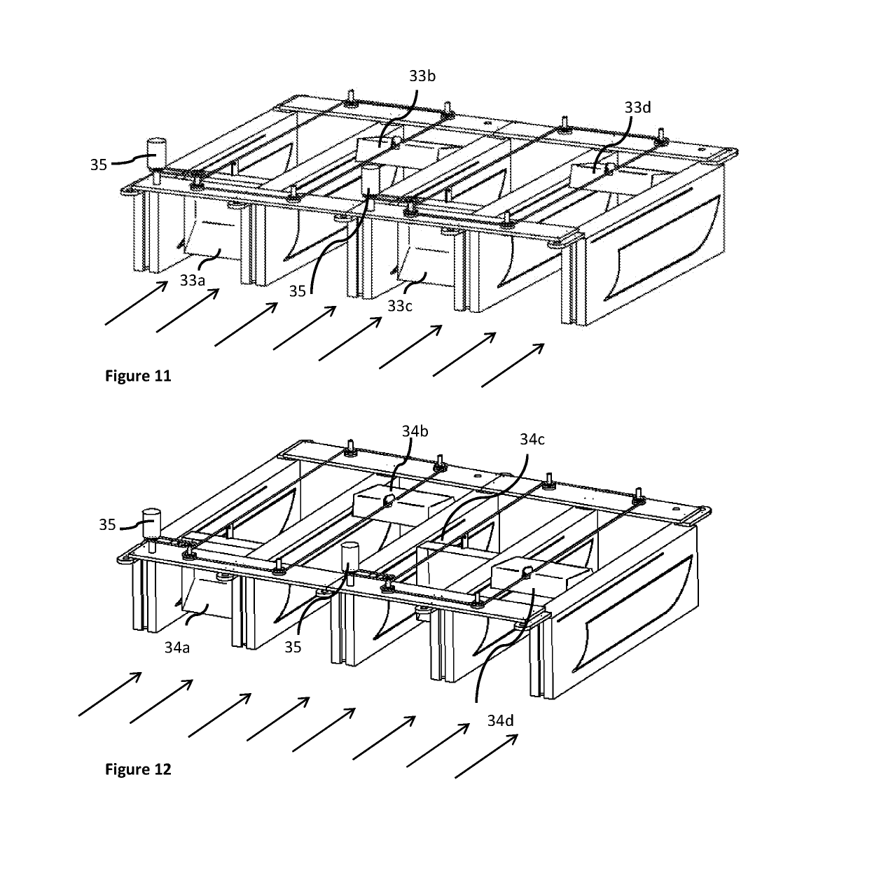

FIG. 11 shows an array of two two-paddles motor modules operating assembled in parallel. Each motor module is composed of two paddles moving on opposed phases of the cycle, being paddles 33a and 33b from module one and paddles 33c and 33d from module two. In FIG. 11 the paddles of both modules run synchronously, being paddles 33a and 33c at the same relative position on the cycle, as well as paddles 33b and 33b. This synchronicity is desired to produce the highest power possible out of the system during the driving strokes of both pairs of paddles running together. This arrangement of paddles would require an external source of energy from energy accumulator elements like described before to allow a continuous running of the system, and for getting out a continuous movement of the transmission and power generation elements especially when the pairs of paddles pass on the transitional phases of the cycle. There is no limitation regarding the number of modules being assembled in parallel, or if the total number of paddles of the array must be even or odd. Hence it could be obtained a three-paddle motor array, four-paddle motor array, five-paddle motor array and so on.

FIG. 12 shows an synchronous array of paddles of two motor modules assembled in parallel with dephased paddles between modules. Paddles 34a and 34b belong to motor module one and paddles 34c and 34d belong to motor module two. It can be seen for that particular moment in FIG. 12 how while paddle 34a is at the beginning of the driving stroke paddle 34c is at the middle of the driving stroke, as well as paddles 34b and 34d are at different stages of the driven stroke. The main advantage of this non synchronicity between modules lays on the continuity of the movement of the transmission and power generation elements along the cycle, because while one of the modules is on one of its transition phase, one of the paddles of the other module is during its driving stroke, making the mechanical output of the motor more uniform.

The power generation elements 35 on FIG. 11 and FIG. 12 can be independent for each motor module, interconnected or both.

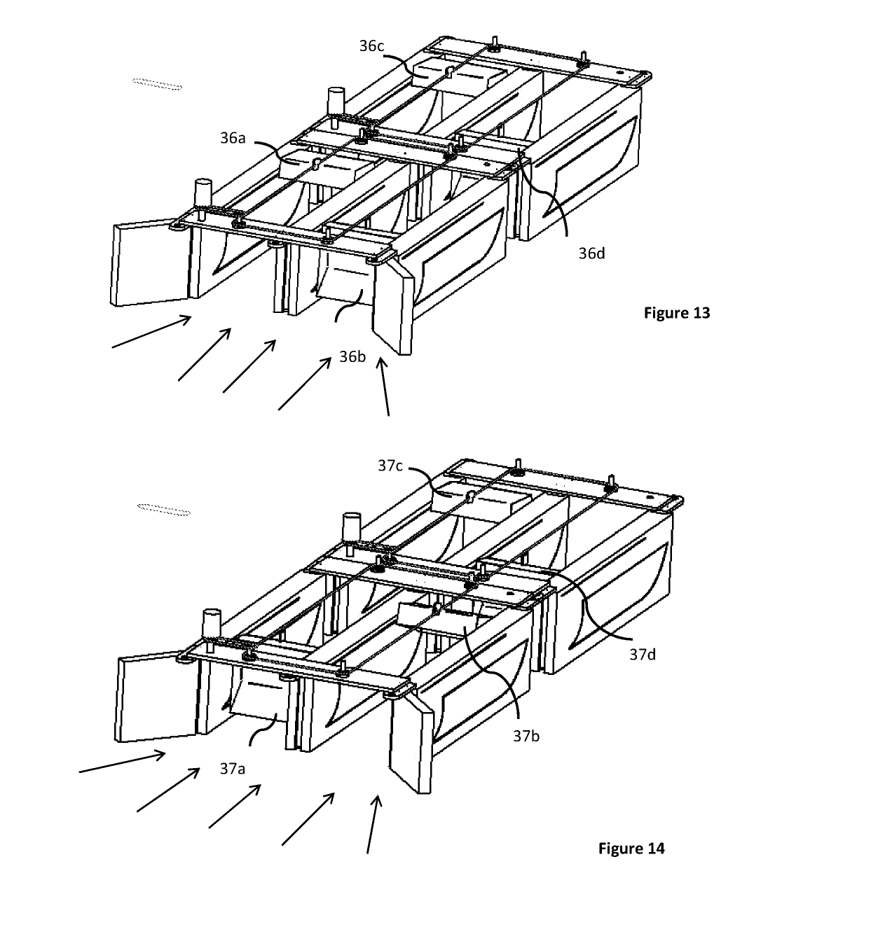

FIG. 13 shows an array of two two-paddle motor modules operating assembled in series. The paddles 36a and 36b belong to the motor module one, located upstream of both, and paddles 36c and 36d belong to motor module two. In this arrangement the paddles 36a and 36c are in-phase both moving at the same stage of the driven stroke, as well as paddles 36b and 36d which are at the same stage of the driving stroke. Those pair of paddles can be linked by the transmission element. The main advantage of this arrangement is to produce a higher output of power during the driving stroke, not necessarily twice the output of a single module because the water current could reduce its speed after passing the module located upstream.

FIG. 14 shows an array of two two-paddle motor modules operating assembled in series where the consecutive paddles of both modules are opposed on the phase of the cycle in such a way that no paddle upstream can obstruct or decelerate the water current received by its consecutive downstream paddle. Paddles 37a and 37b belong to the motor module located upstream while paddles 37c and 37d belong to the other motor module.

FIG. 15 shows an arrangement of two two-paddle motor modules in series staggered, in a manner that the water channels formed by the floating walls of the upstream module 38a, 38b, 38c are not aligned with the water channel formed by the floating walls 39a, 39b, 39c of the downstream module.

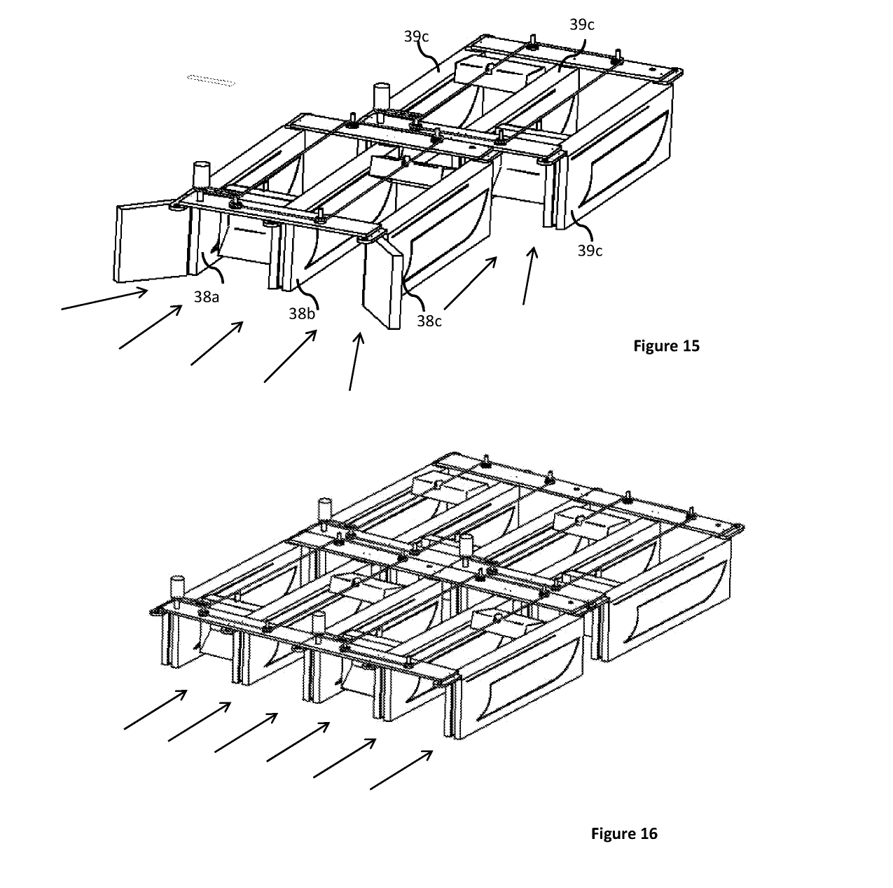

FIG. 16 shows an arrangement of motor modules some assembled in series as well as in parallel. Those modules can operate with their transmission totally engaged, partially engaged or completely independent, with their power generation elements independent, shared or interconnected, with their paddles synchronous or asynchronous, phased or not phased, with same size modules or different size ones, physically staggered or aligned, or with any other possible combination mentioned on this document or derived from the intent of this apparatus or arrangements of it.

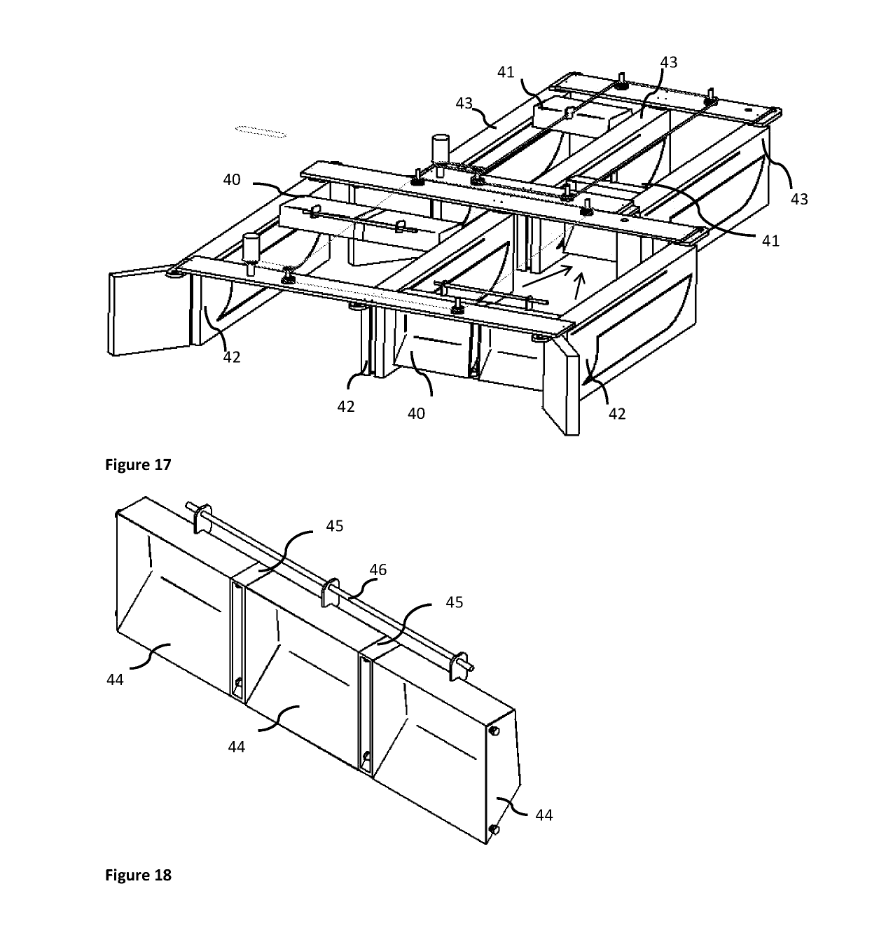

FIG. 17 shows an arrangement of two two-paddles motor modules in series where the module located upstream has wider sized paddles 40 than the downstream ones 41. This arrangement is useful to create water acceleration as the water flows from a wider channel formed by floating walls 42 into a narrower channel downstream formed by floating walls 43.

FIG. 18 shows a wider sized modular composed paddle, like the paddle 40 on FIG. 17. This composed paddle is formed by a number of regular paddles 44 assembled together by means of interface pieces 45 and stiffener elements 46. With these modular elements it is possible to create different size paddles that allow configure different geometries of motors in place, to better adapt to the water source conditions and to achieve different power generation objectives. Besides the flexibility to create different geometries with a pool of the few shareable components a main advantage of this modular component system is that this changes can be achieved on location without requiring special tooling or highly skilled personnel, which worth on remote and hard to access locations. The easy to assemble components is also an advantage for transportation matters, because it implies that the hydrokinetic motor can be shipped completely broken down into single pieces saving space in ships and being splitted in several shipments. From a maintainability point of view the modularity of components allows to handle a small number of spare parts and in some cases combine different parts from failed motor modules to get a fewer number of motor modules up running.

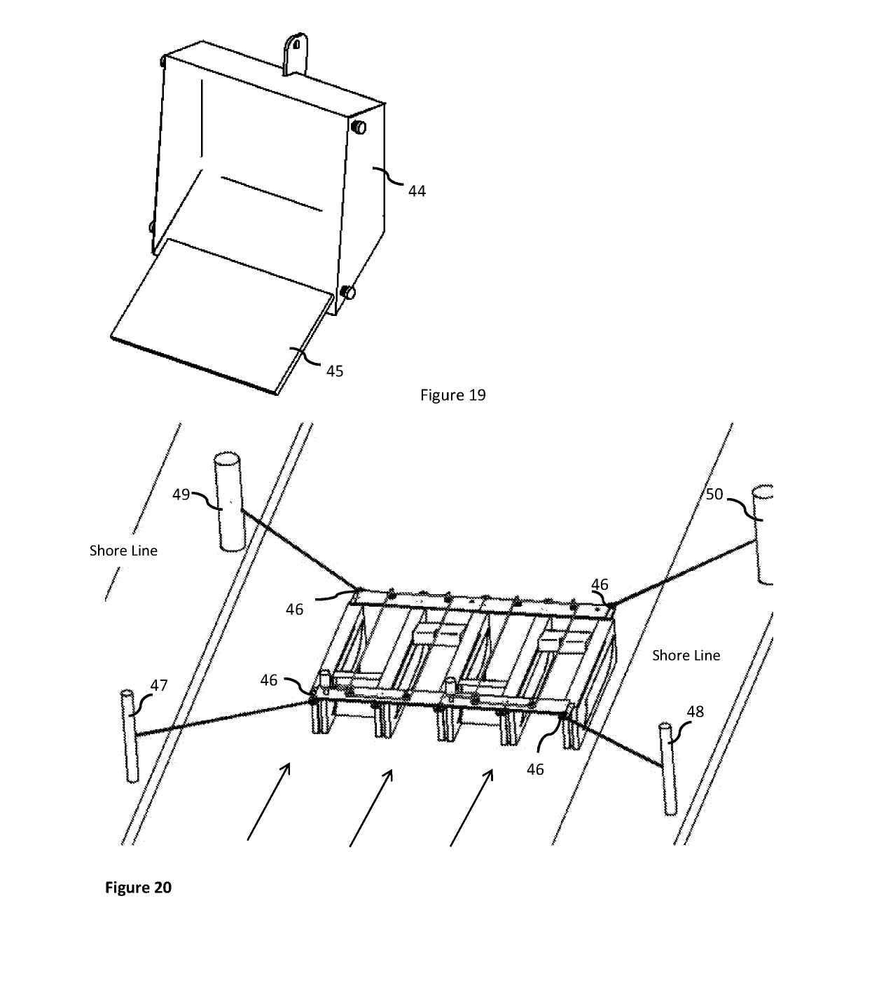

FIG. 19 shows a modular area enlarger 45 for the regular paddle 44, which increase the area being dragged by the water current, increasing the force transmitted by the paddle. This enlarger element 45 can be attached fixed to the paddle, remaining on the same position during all the operating cycle of the paddle, or can adjust its position in order to stay on the most enlarged position during the driving stroke and once the paddle rotates to get out of the water the element 45 modifies its relative position respect the paddle 44 shortening its protruding volume, staying inside of the border area of the paddle 44. The mechanism to achieve this relative movement can be a cam-follower system, a bistable mechanism, a folding plate mechanism, or any other mechanism that allows accomplish the referred objective. In the case of a fixed enlarger 45 is used, the motor could be provided with a set of different sizes paddle enlargers in order the user can install the one that better suits its requirements.

FIG. 20 shows a typical anchorage solution for the present invention. Every module of the apparatus is provided with the anchoring hubs 46 (detailed on FIG. 5 element 14), which allow to attach the motor to any fixed post located outside or inside the water source. FIG. 20 shows a four cable configuration, each cable diagonally thrown to a post in different direction, upstream leftwards 47, upstream rightwards 48, downstream leftwards 49 and downstream rightwards 50. The anchoring is important not only to allow the motor to stand on the same position on the water source or river, but also to ensure the motor is always oriented with its floating walls parallel to the water current in order to receive the maximum speed of water on the paddles and channels. One of the advantages to use several motor modules joined together instead of installing them isolated is to use the minimum number of anchorage points on the water source as possible.

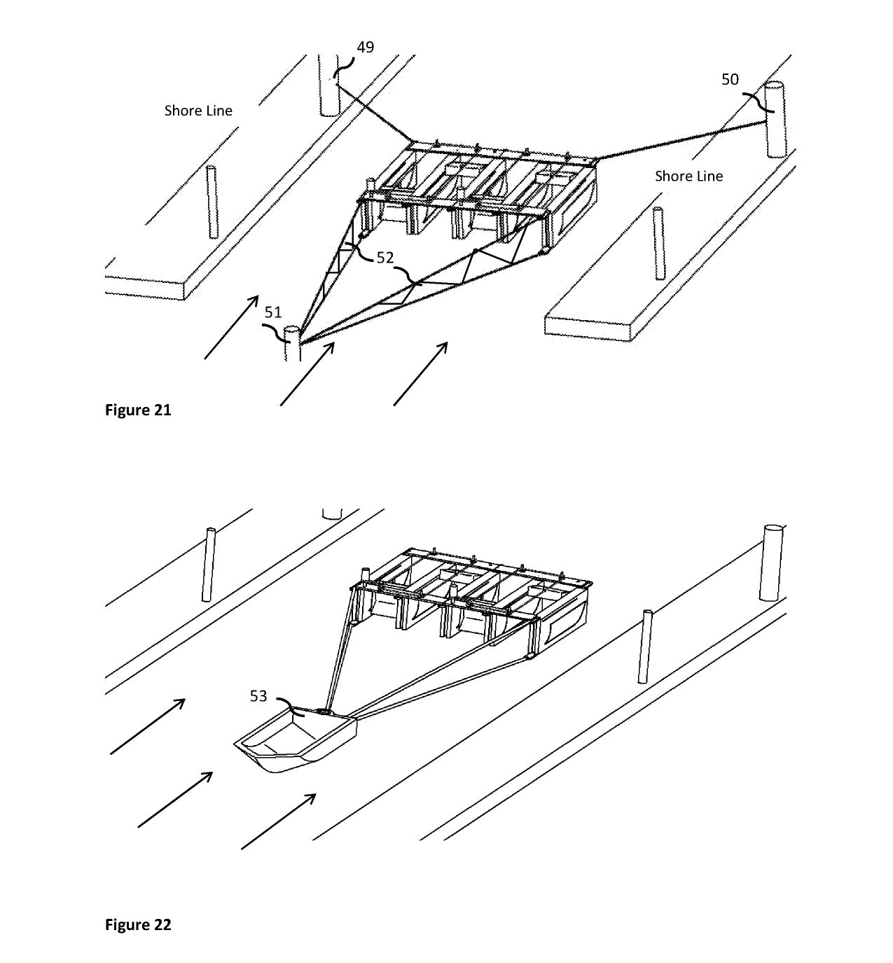

FIG. 21 shows another anchorage solution for the hydrokinetic modular motor. The upstream anchoring of the apparatus consists on cables thrown from the four corner anchoring hubs located on the outmost part of the motor to a single fixed post or anchor located on the water source. The main advantage of this solution is to provide an extra protection against bid bodies being carried by the water, because of the deflecting effect of the upstream anchoring cables. A cable mesh 52 is made to avoid the bodies to get into the water channel and harm the device. The downstream anchoring consists of two cables thrown to a fixed post downstream leftwards 49, and downstream rightwards 50 respect the motor, located inside or outside of the water.

FIG. 22 shows an alternative mode of use of the present invention. The hydrokinetic modular motor can be dragged or moved by any kind of moveable body or ship or vessel 53 in order to generate mechanical power, which could be used to drive electrical generators or any kind of mechanical devices like pumping systems, mixers or any other kind of machinery requiring a mechanical power supply.

While the preferred embodiment and various alternative embodiments of the invention have been disclosed and described in detail herein, it may be apparent to those skilled in the art that various changes in form and detail may be made therein without departing from the spirit and scope thereof.

1. A power generation apparatus for generating power from water flows, the power generation apparatus comprising:
a transducer from hydraulic to mechanical energy comprising a hydraulic side and a mechanical side;
a generator coupled to the mechanical side of the transducer;
wherein the hydraulic side of the transducer comprises a guiding mechanism and a series of paddles adapted to move along the guiding mechanism, the guiding mechanism comprising:
a driving path that defines a linear movement along the guiding mechanism in a downstream direction; and
a driven path that defines a linear movement along the guiding mechanism in an upstream direction, being the driving path and the driven path parallel paths and being the apparatus configured so that the driving path have a higher dragging coefficient than the driven path.

2. The power generation apparatus according to claim 1, wherein the apparatus comprises a transition element that changes the direction of the guiding mechanism between the upstream direction and the downstream direction.

3. The power generation apparatus according to claim 2, wherein the transition element comprises an actuator to change the effective area of the paddles.

4. The power generation apparatus according to claim 3, wherein the actuator is configured to rotate at least one of the paddles.

5. The power generation apparatus according to claim 2, wherein the transition element comprises a no-return mechanism.

6. The power generation apparatus according to claim 1, wherein the paddles are driven with a larger effective area to the water flow during the driving path and with a lower effective area to the water flow during the driven path.

7. The power generation apparatus according to claim 1, wherein the guiding mechanism drives the paddles with a larger area outside the water flow during the driven path.

8. The power generation apparatus according to claim 7, wherein the apparatus further comprises a floating wall configured to maintain the paddles during the driving path substantially underwater and during the driven path substantially over the water flow.

9. The power generation apparatus according to claim 1, wherein the apparatus comprises at least two paddles.

10. The power generation apparatus according to claim 1, wherein each paddle is attached to the guide by means of at least one follower that moves along the guide.

11. The power generation apparatus according to claim 1, further comprising an accumulator connected to the generator.

12. The power generation apparatus according to claim 11, wherein the accumulator is also connected to a motor for moving at least one of the paddles during the driven path.

13. The power generation apparatus according to claim 11, wherein the accumulator is a battery.

14. The power generation apparatus according to claim 11, wherein the accumulator is a flywheel.

15. The power generation apparatus according to claim 11, wherein the accumulator is a spring arrangement.

16. The power generation apparatus according to claim 1, further comprising a second power generation apparatus connected in series or in parallel.

17. The power generation apparatus according to claim 1, further comprising an anchoring hub adapted to be anchored to a post.

18. The power generation apparatus according to claim 17, wherein the post is located upstream from the apparatus.

19. The power generation apparatus according to claim 18, wherein the anchoring hub is attached to the post by means of a cable.

20. The power generation apparatus according to claim 18, wherein the anchoring hub is attached to the post by means of a cable mesh.

21. The power generation apparatus according to claim 17, wherein the post is located outside the water flow.
